(19) United States
(12) Patent Application Publication
(10) Pub. No.: US 2023/0418831 A1
(43) Pub. Date: Dec. 28, 2023

(54) GENERATING A CUSTOMER JOURNEY BASED ON REASONS FOR CUSTOMER INTERACTIONS AND TIMES BETWEEN CUSTOMER INTERACTIONS

(71) Applicant: Accenture Global Solutions Limited, Dublin (IE)

(72) Inventors: Surya Raghavendra VADLAMANI, Newtown, PA (US); Arun VENKATESAN, Bangalore (IN); Mohammad ZUHAIB, Noida (IN); Shreya THAKARE, Thane (IN); Brandon Nicholas BUTZ, Atlanta, GA (US)

(21) Appl. No.: 17/849,002

(22) Filed: Jun. 24, 2022

(51) Int. Cl. G06F 16/248; G06F 16/22; G06F 16/2455

(52) U.S. Cl. CPC G06F 16/248; G06F 16/2282; G06F 16/2456

(57) ABSTRACT

A device may receive raw data and metadata associated with a customer, and may transform the raw data and the metadata into unified data. The device may process the unified data, with a first model, to generate journey record derived variables, customer record derived variables, clickstream derived variables, and analytical matrices, and may process the unified data, the journey record derived variables, the customer record derived variables, the clickstream derived variables, and the analytical matrices, with a second model, to generate a journey data store with journey derived signals. The device may process the unified data, the journey record derived variables, the customer record derived variables, the clickstream derived variables, the analytical matrices, and the journey data store, with a third model, to generate overall statistical data for the customer, and may perform one or more actions based on the overall statistical data.

### BACKGROUND

Many entities (e.g., businesses, government agencies, and/or the like) observe customer interactions in silos or attempt to determine a wholistic view of customer interactions.

### SUMMARY

Some implementations described herein relate to a method. The method may include receiving raw data and metadata associated with a customer, and transforming the raw data and the metadata into unified data. The method may include processing the unified data, with a first model, to generate journey record derived variables, customer record derived variables, clickstream derived variables, and analytical matrices, and processing the unified data, the journey record derived variables, the customer record derived variables, the clickstream derived variables, and the analytical matrices, with a second model, to generate a journey data store with journey derived signals. The method may include processing the unified data, the journey record derived variables, the customer record derived variables, the clickstream derived variables, the analytical matrices, and the journey data store, with a third model, to generate overall statistical data for the customer, and performing one or more actions based on the overall statistical data.

Some implementations described herein relate to a device. The device may include one or more memories and one or more processors coupled to the one or more memories. The one or more processors may be configured to receive raw data and metadata associated with a customer, and transform the raw data and the metadata into unified data. The one or more processors may be configured to process the unified data, with a first model, to generate journey record derived variables, customer record derived variables, clickstream derived variables, and analytical matrices, and process the unified data, the journey record derived variables, the customer record derived variables, the clickstream derived variables, and the analytical matrices, with a second model, to generate a journey data store with journey derived signals. The journey data store may include an end-to-end stitched journey view table and the journey derived signals may include derived attributes calculated from the journey data store. The one or more processors may be configured to process the unified data, the journey record derived variables, the customer record derived variables, the clickstream derived variables, the analytical matrices, and the journey data store, with a third model, to generate overall statistical data for the customer, and may perform one or more actions based on the overall statistical data.

Some implementations described herein relate to a non-transitory computer-readable medium that stores a set of instructions for a device. The set of instructions, when executed by one or more processors of the device, may cause the device to receive raw data and metadata associated with a customer, and transform the raw data and the metadata into unified data. The set of instructions, when executed by one or more processors of the device, may cause the device to process the unified data, with a first model, to generate journey record derived variables, customer record derived variables, clickstream derived variables, and analytical matrices, and process the unified data, the journey record derived variables, the customer record derived variables, the clickstream derived variables, and the analytical matrices, with a second model, to generate a journey data store with journey derived signals. The set of instructions, when executed by one or more processors of the device, may cause the device to process the unified data, the journey record derived variables, the customer record derived variables, the clickstream derived variables, the analytical matrices, and the journey data store, with a third model, to generate overall statistical data for the customer, and provide the overall statistical data for display.

### BRIEF DESCRIPTION OF THE DRAWINGS

FIGS. 1A-1F are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process for generating a customer journey based on reasons for customer interactions and times between customer interactions.

### DETAILED DESCRIPTION

The following detailed description of example implementations refers to the accompanying drawings. The same reference numbers in different drawings may identify the same or similar elements.

Creating a customer journey (e.g., experiences of customers when interacting with something, such as an interactive voice response system, a web site, a chat bot, and/or the like) may only begin after a stitched customer journey identifier is created. However, current customer journey stitching systems are disparate and fail to store a single record of all customer interactions in a journey format. This causes the current customer journey stitching systems to utilize large quantities of data to calculate events for decisioning and to utilize complex procedures and multiple application programming interface (API) calls to aggregate the data. Thus, entities are unable to perform actions for a customer based on a current customer journey. Current customer data platforms allow an entity to track a customer across a customer lifecycle, but fail to create micro-journeys based on customer reasons. The current customer data platforms fail to execute a customer journey analysis across all channels, and based on recent interactions, since analytics teams are siloed and cross-channel analytics is insufficient to define a customer journey. Thus, entities are unable to determine a true customer experience, a customer sentiment, or a stage in customer lifecycle, which results in creation of poor customer experiences.

Therefore, the current customer journey stitching systems and the current customer data platforms consume computing resources (e.g., processing resources, memory resources, communication resources, and/or the like), networking resources, and/or the like associated with requiring an inordinate quantity of time to generate a poor or incomplete customer journey, performing incorrect actions based on the poor or incomplete customer journey, losing customers based on performing the incorrect actions, and/or the like.

Some implementations described herein relate to an analysis system that generates a customer journey based on reasons for customer interactions and times between customer interactions. For example, the analysis system may receive raw data and metadata associated with a customer, and may transform the raw data and the metadata into unified data. The analysis system may process the unified data, with a first model, to generate journey record derived variables, customer record derived variables, clickstream derived variables, and analytical matrices, and may process the unified data, the journey record derived variables, the customer record derived variables, the clickstream derived variables, and the analytical matrices, with a second model, to generate a journey data store with journey derived signals. The analysis system may process the unified data, the journey record derived variables, the customer record derived variables, the clickstream derived variables, the analytical matrices, and the journey data store, with a third model, to generate overall statistical data for the customer, and may perform one or more actions based on the overall statistical data.

In this way, the analysis system generates a customer journey based on reasons for customer interactions and times between customer interactions. The analysis system may generate a unified view of customer interactions across multiple touchpoints, and may utilize an intent of a customer and a duration between touchpoints. The analysis system may generate an individual customer journey based on definitions, calculations, intents (e.g., reasons) behind customer interactions, time between individual customer interactions, and/or the like. The generated customer journey may be utilized to create event-based business rules in real-time decisioning platforms, may enable an entity to identify new key performance indicators (KPIs) associated with a customer, and/or may provide insights about a true customer journey. This, in turn, conserves computing resources, networking resources, and/or the like that would otherwise have been consumed in requiring an inordinate quantity of time to generate a poor or incomplete customer journey, performing incorrect actions based on the poor or incomplete customer journey, losing customers based on performing the incorrect actions, and/or the like.

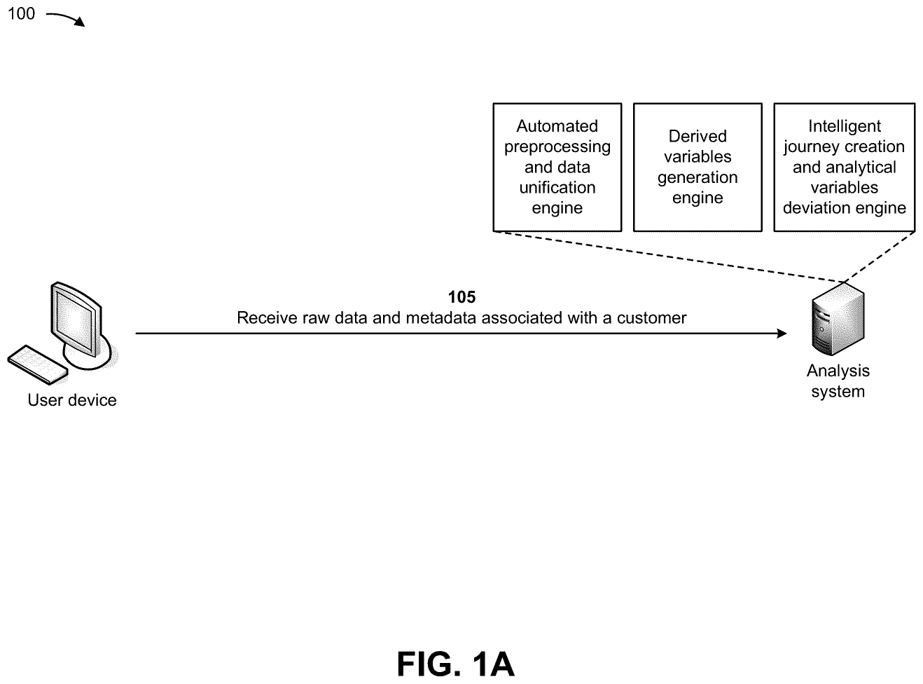

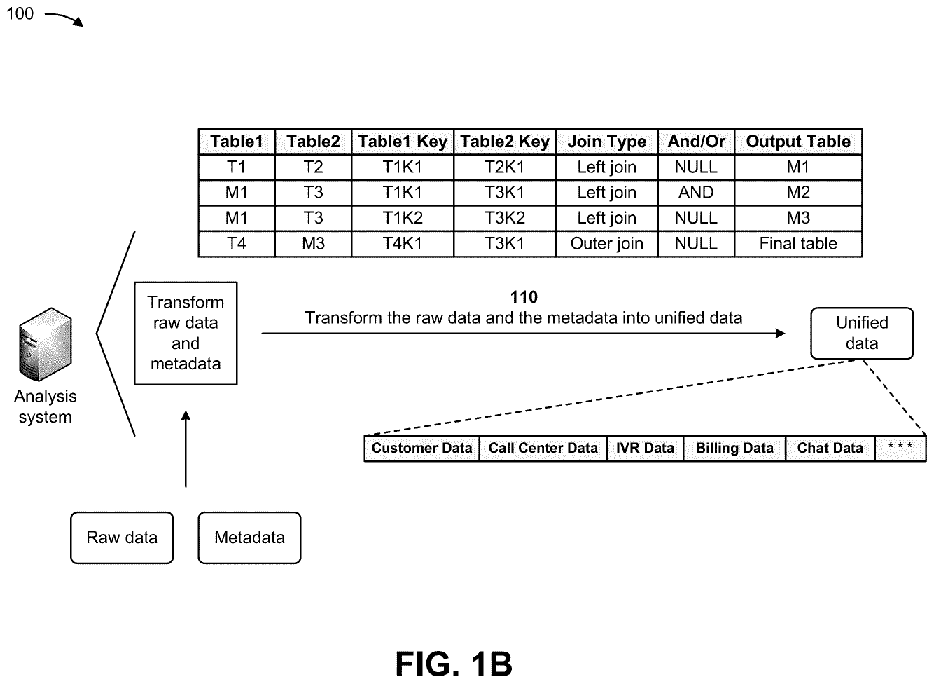

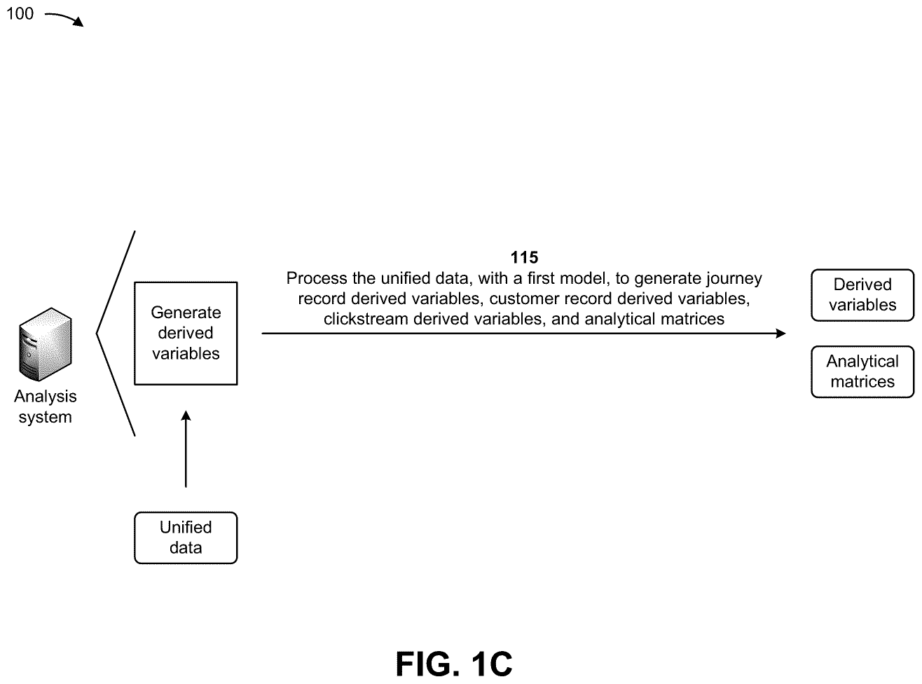

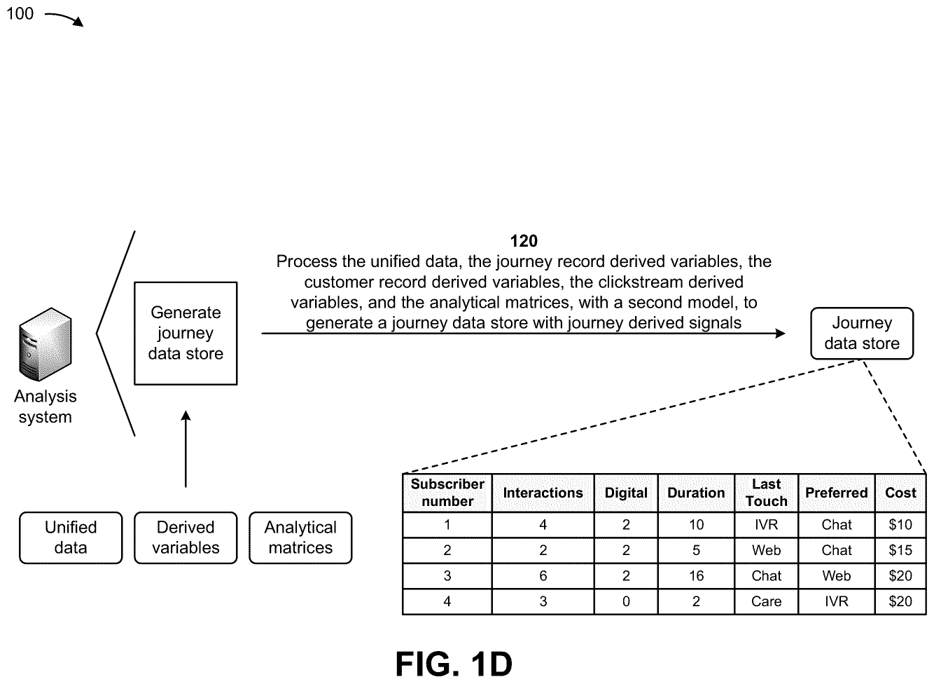

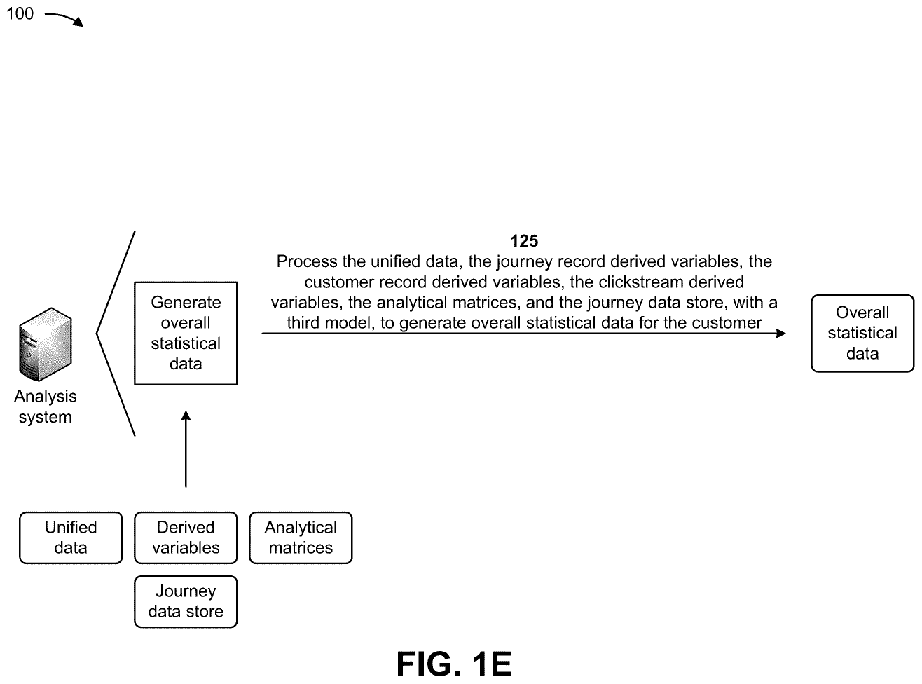

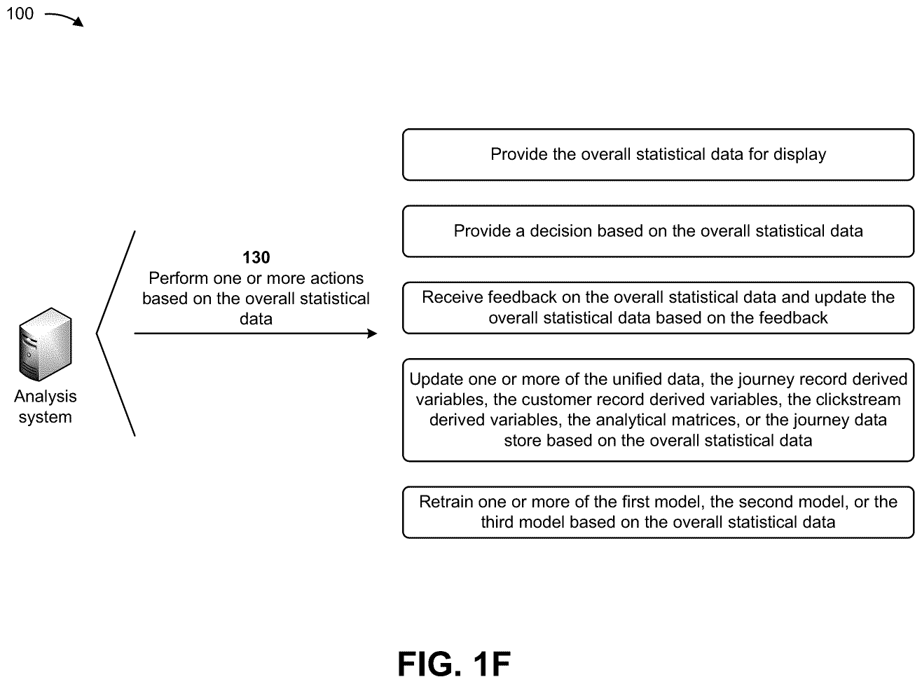

FIGS. 1A-1F are diagrams of an example 100 associated with generating a customer journey based on reasons for customer interactions and times between customer interactions. As shown in FIGS. 1A-1F, example 100 includes a user device associated with an analysis system. The user device may include a wireless communication device, a mobile phone, a laptop computer, a tablet computer, a desktop computer, and/or the like. The analysis system may include a system that generates a customer journey based on reasons for customer interactions and times between customer interactions. Further details of the user device and the analysis system are provided elsewhere herein.

As shown in FIG. 1A, the analysis system may include an automated preprocessing and data unification engine, a derived variables generation engine, and an intelligent journey creation and analytical variables deviation engine. The automated preprocessing and data unification engine may be configured to clean, map, and transform data for uniform consumption in an automated process. The derived variables generation engine may be configured to calculate attributes that may be utilized to calculate a customer journey and KPIs associated with the customer journey. The intelligent journey creation and analytical variables deviation engine may be configured to stitch customer interaction time intervals and customer intents to generate the customer journey. Further details of the automated preprocessing and data unification engine, the derived variables generation engine, and the intelligent journey creation and analytical variables deviation engine are provided below.

As further shown in FIG. 1A, and by reference number 105, the analysis system may receive raw data and metadata associated with a customer. For example, the user device may provide the raw data and the metadata associated with the customer to the analysis system. In some implementations, the analysis system may continuously receive the raw data and the metadata, may periodically receive the raw data and the metadata, or may receive the raw data and the metadata based on requesting the raw data and the metadata. In some implementations, the analysis system may receive the raw and the metadata from a variety of sources, such as an interactive voice response (IVR) system associated with the customer, online interactions associated with the customer, applications utilized by the customer, text messages associated with the customer, a call center associated with the customer, chat messages associated with the customer, and/or the like. In some implementations, the raw data and the metadata may vary based on organizations associated with the raw data and the metadata, industries associated with the raw data and the metadata, customers associated with the raw data and the metadata, and/or the like.

The raw data may include data identifying IVR interactions associated with the customer, online interactions associated with the customer, application interactions associated with the customer, text messages associated with the customer, call center calls associated with the customer, chat messages associated with the customer, and/or the like. In some implementations, the raw data may include data provided in a customer table (e.g., identifying a customer profile), a billing table (e.g., identifying customer billing information), a touchpoints data table (e.g., identifying customer interactions), a ticket table (e.g., identifying customer tickets), a dispatch table (e.g., identifying customer deliveries), a dropship table (e.g., identifying customer purchases), a products table (e.g., identifying products purchased by the customer), a services table (e.g., identifying services purchased by the customer), and/or the like.

In some implementations, the metadata may include table to column information metadata, table join information metadata, and/or the like. The table to column information metadata may include a list of predefined attributes that are present in the raw data. The list may include standard names of attributes that are mapped to original names of the attribute names and to an original name of a table. The table join information metadata may include source table names, join operations to be performed between tables, keys to perform the join operations, and/or the like. In some implementations, the metadata may include additional input parameters, such as input from an entity defining how a process executes, how an output is generated, and/or the like.

As shown in FIG. 1B, and by reference number 110, the analysis system may transform the raw data and the metadata into unified data. For example, when transforming the raw data and the metadata into the unified data, the analysis system may perform a data sanity check on the raw data and the metadata, may perform a datatype standardization on the raw data and the metadata, may perform an attributes fixation on the raw data and the metadata, may perform a data unification on the raw data and the metadata, may perform an attributes name standardization on the raw data and the metadata, may perform a data format customization on the raw data and the metadata, and/or the like, to transform the raw data and the metadata into the unified data. In some implementations, the unified data may include the raw data and the metadata provided in a standardized format required for further processing.

When performing the data sanity check on the raw data and the metadata, the analysis system may validate the raw data, the metadata, and datatypes associated with the raw data and the metadata. When performing the datatype standardization on the raw data and the metadata, the analysis system may convert the datatypes (e.g., assigned to attributes) associated with the raw data and the metadata into a standard datatype (e.g., a single standard datatype for simplicity of further processing). When performing the attributes fixation on the raw data and the metadata, the analysis system may fix attributes associated with the raw data and the metadata. For example, the analysis system may prefix the attributes with respective table names to eliminate attribute redundancy across the tables. When performing the data unification on the raw data and the metadata, the analysis system may join the raw data based on joining criteria provided in the metadata. For example, the raw data may be joined based on data points at an aggregation level. When performing the attributes name standardization on the raw data and the metadata, the analysis system may convert names of the attributes into standard names based on the metadata. When performing the data format customization on the raw data and the metadata, the analysis system may convert data types of the attributes into a standard format. In some implementations, the analysis system may store the unified data in a data structure (e.g., a database, a table, a list, and/or the like) associated with the analysis system.

As shown in FIG. 1C, and by reference number 115, the analysis system may process the unified data, with a first model, to generate journey record derived variables, customer record derived variables, clickstream derived variables, and analytical matrices. For example, the first model may analyze the unified data and may identify the journey record derived variables, the customer record derived variables, the clickstream derived variables, and the analytical matrices based on analyzing the unified data. The journey record derived variables may include analytical variables (e.g., an analytical variables matrix) that are derived based on customer-specific data of the unified data. The customer-specific data may include customer intents, time periods associated with the customer-specific data, identifiers associated with the customer, and/or the like. The customer record derived variables may include analytical variables (e.g., an analytical variables matrix) derived based on customer interaction level aggregated data of the unified data. The clickstream derived variables may include clickstream specific derived signals merged with the journey record derived variables. The clickstream specific derived signals may include clickstream source data and metadata for standardizing names of clickstream attributes into standard names.

The analytical matrices may include a matrix identifying a mean among data points of the unified data and a matrix identifying a variance among the data points of the unified data. For example, the first model may calculate mean values among the data points of the unified data and may create the matrix identifying the mean among the data points of the unified data based on the calculated mean values. The first model may calculate variance values among the data points of the unified data and may create the matrix identifying the variance among the data points of the unified data based on the calculated variance values.

As shown in FIG. 1D, and by reference number 120, the analysis system may process the unified data, the journey record derived variables, the customer record derived variables, the clickstream derived variables, and the analytical matrices, with a second model, to generate a journey data store with journey derived signals. For example, the analysis system may generate a customer journey based on reasons for customer interactions and time between customer interactions, as identified in one or more of the unified data, the journey record derived variables, the customer record derived variables, the clickstream derived variables, and/or the analytical matrices. In some implementations, when processing the unified data, the journey record derived variables, the customer record derived variables, the clickstream derived variables, and the analytical matrices, with the second model, to generate the journey data store with the journey derived signals, the analysis system (e.g., via the second model) may generate a single unified base table for computing a customer journey based on intermediate tables (e.g., the unified data, the journey record derived variables, the customer record derived variables, the clickstream derived variables, and the analytical matrices). The analysis system (e.g., via the second model) may perform journey stitching on the base table to generate an end-to-end unified view of the customer journey (e.g., the journey data store). The analysis system (e.g., via the second model) may process and standardize the journey data store to convert data into a uniform level, and may calculate the journey derived signals.

The journey data store may include an end-to-end stitched journey view table and the journey derived signals may include derived attributes calculated from the journey data store. In some implementations, the journey derived signals may include decision signals derived based on the customer journey and calculated based on interaction channels of the customer, whether the customer journey is complete or incomplete, whether the customer journey is successful or unsuccessful, touchpoints of the customer, a time granularity of the customer journey, an intent of the customer journey, whether the customer journey includes human or non-human interaction, whether the customer journey is digital or non-digital, whether the customer journey includes multiple channels, and/or the like.

In some implementations, when processing the unified data, the journey record derived variables, the customer record derived variables, the clickstream derived variables, and the analytical matrices, with the second model, to generate the journey data store with the journey derived signals, the analysis system (e.g., via the second model) may identify or associate the customer with interactions based on a customer identifier, and may calculate a difference between start times of two interactions based on the customer identifier being associated with the two interactions. The analysis system (e.g., via the second model) may perform journey stitching based on the difference between the start times being less than or equal to a journey day, and may provide the two interactions in the journey data store based on the customer identifier being associated with the two interactions and based on the difference between the start times being less than or equal to the journey day.

As shown in FIG. 1E, and by reference number 125, the analysis system may process the unified data, the journey record derived variables, the customer record derived variables, the clickstream derived variables, the analytical matrices, and the journey data store, with a third model, to generate overall statistical data for the customer (e.g., a customer journey). For example, the third model may analyze the unified data, the journey record derived variables, the customer record derived variables, the clickstream derived variables, the analytical matrices, and the journey data store, and may generate the overall statistical data for the customer based on analyzing the unified data, the journey record derived variables, the customer record derived variables, the clickstream derived variables, the analytical matrices, and the journey data store. In some implementations, the third model may generate a user interface that includes the overall statistical data for the customer. For example, the user interface may include overall statistical data identifying customer engagement (e.g., total journeys, quantity of interactions, average interactions per journey, a percent of first touch points, a percent of last touch points, and/or the like), customer communication channels (e.g., a call center, a chatbot, an IVR system, a retail system, the web, and/or the like), the customer journeys, customer intent behind an interaction, times between customer interactions, cost of a customer interaction, and/or the like. In this way, the analysis system may enable an entity to perform real-time decisions for the customer, generate event-based business rules for the customer, analyze key performance indicators associated with the customer, receive insights on the customer journey, and/or the like.

As shown in FIG. 1F, and by reference number 130, the analysis system may perform one or more actions based on the overall statistical data. In some implementations, performing the one or more actions includes the analysis system providing the overall statistical data for display. For example, the analysis system may provide information identifying the overall statistical data to the user device, and the user device may display the information identifying the overall statistical data to a user of the user device. In this way, the analysis system may conserve computing resources, networking resources, and/or the like that would otherwise have been consumed in requiring an inordinate quantity of time to generate a poor or incomplete customer journey, performing incorrect actions based on the poor or incomplete customer journey, losing customers based on performing the incorrect actions, and/or the like.

In some implementations, performing the one or more actions includes the analysis system providing a decision based on the overall statistical data. For example, the analysis system may determine a decision for the customer (e.g., offer a product and/or a service, provide a free product or service, offer a rebate, and/or the like) based on the overall statistical data. The analysis system may provide information identifying the decision to the user device, and the user device may display the information identifying the decision to the user. In this way, the analysis system may conserve computing resources, networking resources, and/or the like that would otherwise have been consumed in performing incorrect actions based on the poor or incomplete customer journey, losing customers based on performing the incorrect actions, and/or the like.

In some implementations, performing the one or more actions includes the analysis system receiving feedback on the overall statistical data and updating the overall statistical data based on the feedback. For example, the analysis system may provide the overall statistical data to the user device and a user may utilize the user device to review and provide the feedback on the overall statistical data. The user device may provide the feedback to the analysis system, and the analysis system may update the overall statistical data based on the feedback. In this way, the analysis system may conserve computing resources, networking resources, and/or the like that would otherwise have been consumed in requiring an inordinate quantity of time to generate a poor or incomplete customer journey, and/or the like.

In some implementations, performing the one or more actions includes the analysis system updating one or more of the unified data, the journey record derived variables, the customer record derived variables, the clickstream derived variables, the analytical matrices, or the journey data store based on the overall statistical data. For example, the analysis system may modify one or more of the unified data, the journey record derived variables, the customer record derived variables, the clickstream derived variables, the analytical matrices, or the journey data store based on the overall statistical data and may generate modified overall statistical data based on one or more of the modified unified data, the modified journey record derived variables, the modified customer record derived variables, the modified clickstream derived variables, the modified analytical matrices, or the modified journey data store. In this way, the analysis system may conserve computing resources, networking resources, and/or the like that would otherwise have been consumed in losing customers based on performing the incorrect actions, and/or the like.

In some implementations, performing the one or more actions includes the analysis system retraining one or more of the first model, the second model, or the third model based on the overall statistical data. For example, the analysis system may utilize the overall statistical data as training data for retraining one or more of the first model, the second model, or the third model, thereby increasing the quantity of training data available for training one or more of the first model, the second model, or the third model. Accordingly, the analysis system may conserve computing resources associated with identifying, obtaining, and/or generating historical data for training one or more of the first model, the second model, or the third model relative to other systems for identifying, obtaining, and/or generating historical data for training machine learning models.

Although implementations described herein relate to utilizing the customer journey for digital marketing, the analysis system may utilize the customer journey for analytics and decisioning. With regard to analytics, the analysis system may generate a new set of KPIs associated with a customer journey, rather only reviewing single interactions. For example, the analysis system may calculate a total cost for a customer across the customer journey by adding the total costs across all customer interactions, may utilize pattern recognition to calculate new ways for analyzing churn by analyzing the customer journey as a whole and identifying pain points, may create new types of customer experience scores by stitching surveys or KPIs across the customer journey, may minimize or optimize storage requirements, and/or the like. With regard to decisioning, the analysis system may implement decisioning business rules at the customer journey level, which may improve business side experience results and technical implementations. For example, the analysis system may improve the technical implementations by reducing a quantity of calls, reducing storage requirements, reducing errors when calculating or receiving data through APIs, and/or the like. The analysis system may improve the business side experience results by proactively contacting a customer when the customer journey exceeds a certain quantity of days (e.g., if the customer journey is more than ten days regarding settlement of an insurance claim, an agent may call the customer and resolve the claim), by performing actions when certain actions occur in the customer journey (e.g., if the customer adds a product to a cart more than once, a promotion may be provided to the customer), and/or the like.

In this way, the analysis system generates a customer journey based on reasons for customer interactions and times between customer interactions. The analysis system may generate a unified view of customer interactions across multiple touchpoints, and may utilize an intent of a customer and a duration between touchpoints. The analysis system may generate an individual customer journey based on definitions, calculations, intents (e.g., reasons) behind customer interactions, times between individual customer interactions, and/or the like. The generated customer journey may be utilized to create event-based business rules in real-time decisioning platforms, may enable an entity to identify new key performance indicators (KPIs) associated with a customer, may provide insights about a true customer journey, and/or the like. This, in turn, conserves computing resources, networking resources, and/or the like that would otherwise have been consumed in requiring an inordinate quantity of time to generate a poor or incomplete customer journey, performing incorrect actions based on the poor or incomplete customer journey, losing customers based on performing the incorrect actions, and/or the like.

As indicated above, FIGS. 1A-IF are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-IF. Furthermore, two or more devices shown in FIGS. 1A-IF may be implemented within a single device, or a single device shown in FIGS. 1A-1F may be implemented as multiple, distributed devices. Additionally, or alternatively, a set of devices (e.g., one or more devices) shown in FIGS. 1A-IF may perform one or more functions described as being performed by another set of devices shown in FIGS. 1A-1F.

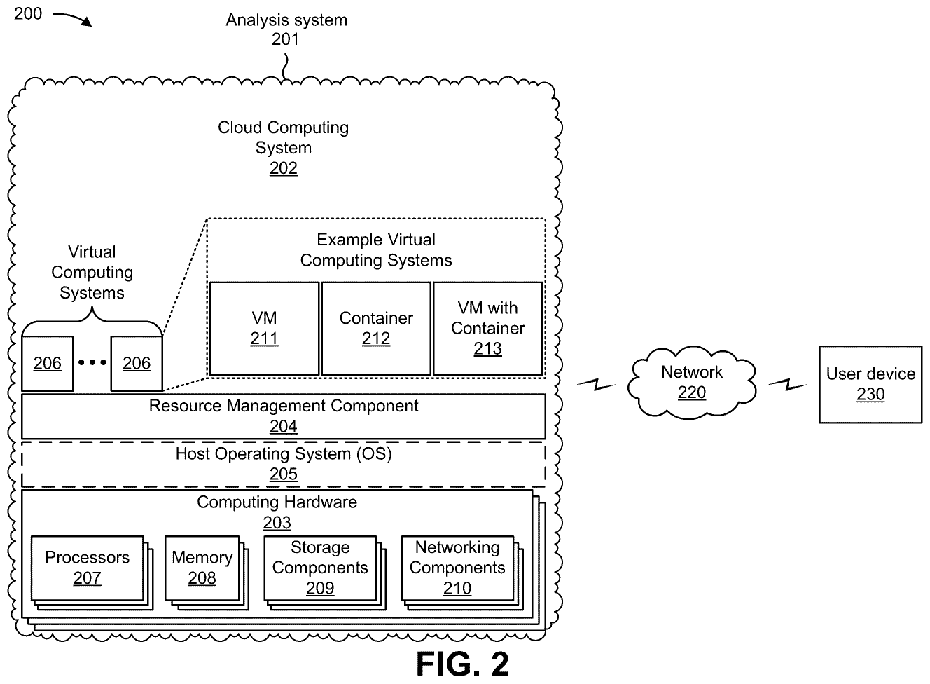

FIG. 2 is a diagram of an example environment 200 in which systems and/or methods described herein may be implemented. As shown in FIG. 2, the environment 200 may include an analysis system 201, which may include one or more elements of and/or may execute within a cloud computing system 202. The cloud computing system 202 may include one or more elements 203-213, as described in more detail below. As further shown in FIG. 2, the environment 200 may include a network 220 and/or a user device 230. Devices and/or elements of the environment 200 may interconnect via wired connections and/or wireless connections.

The cloud computing system 202 includes computing hardware 203, a resource management component 204, a host operating system (OS) 205, and/or one or more virtual computing systems 206. The resource management component 204 may perform virtualization (e.g., abstraction) of the computing hardware 203 to create the one or more virtual computing systems 206. Using virtualization, the resource management component 204 enables a single computing device (e.g., a computer, a server, and/or the like) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing the computing hardware 203 to start, stop, and/or manage the one or more virtual computing systems 206. For example, the resource management component 204 may include a hypervisor (e.g., a bare-metal or Type 1 hypervisor, a hosted or Type 2 hypervisor, and/or the like) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine 211, a container 212, a hybrid environment 213 that includes a virtual machine and a container, and/or the like. A virtual computing system 206 may execute one or more applications using a file system that includes binary files, software libraries, and/or other resources required to execute applications on a guest operating system (e.g., within the virtual computing system 206) or the host operating system 205.

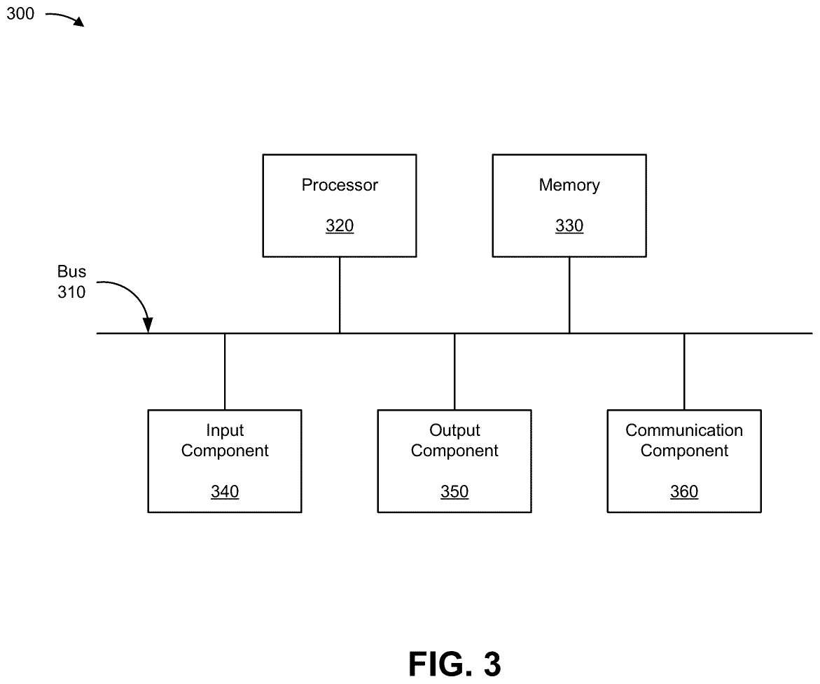

Although the analysis system 201 may include one or more elements 203-213 of the cloud computing system 202, may execute within the cloud computing system 202, and/or may be hosted within the cloud computing system 202, in some implementations, the analysis system 201 may not be cloud-based (e.g., may be implemented outside of a cloud computing system) or may be partially cloud-based. For example, the analysis system 201 may include one or more devices that are not part of the cloud computing system 202, such as the device 300 of FIG. 3, which may include a standalone server or another type of computing device. The analysis system 201 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or the like, and/or a combination of these or other types of networks. The network 220 enables communication among the devices of the environment 200.

The user device 230 includes one or more devices capable of receiving, generating, storing, processing, and/or providing information, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the analysis system 201 and/or the user device 230. In some implementations, the analysis system 201 and/or the user device 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes a component that enables wired and/or wireless communication among the components of device 300. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform a function. The memory 330 includes a random-access memory, a read only memory, and/or another type of memory (e.g., a flash memory, a magnetic memory, and/or an optical memory).

The input component 340 enables the device 300 to receive input, such as user input and/or sensed inputs. For example, the input component 340 may include a touch screen, a keyboard, a keypad, a mouse, a button, a microphone, a switch, a sensor, a global positioning system component, an accelerometer, a gyroscope, an actuator, and/or the like. The output component 350 enables the device 300 to provide output, such as via a display, a speaker, and/or one or more light-emitting diodes. The communication component 360 enables the device 300 to communicate with other devices, such as via a wired connection and/or a wireless connection. For example, the communication component 360 may include a receiver, a transmitter, a transceiver, a modem, a network interface card, an antenna, and/or the like.

The device 300 may perform one or more processes described herein. For example, a non-transitory computer-readable medium (e.g., the memory 330) may store a set of instructions (e.g., one or more instructions, code, software code, program code, and/or the like) for execution by the processor 320. The processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

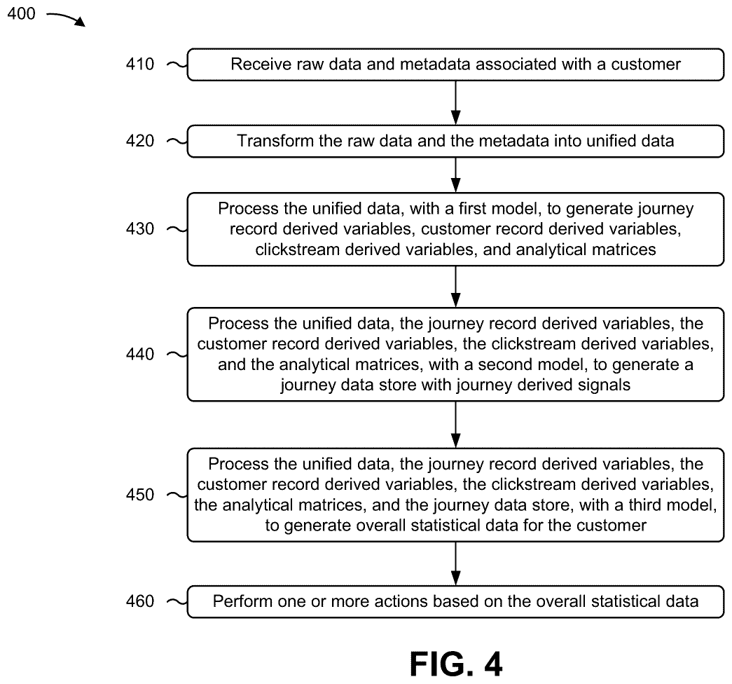

FIG. 4 is a flowchart of an example process 400 for generating a customer journey based on reasons for customer interactions and times between customer interactions. In some implementations, one or more process blocks of FIG. 4 may be performed by a device (e.g., the analysis system 201). In some implementations, one or more process blocks of FIG. 4 may be performed by another device or a group of devices separate from or including the device, such as a user device (e.g., the user device 230). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving raw data and metadata associated with a customer (block 410). For example, the device may receive raw data and metadata associated with a customer, as described above. In some implementations, the raw data may include data provided in one or more of a customer table, a billing table, a touchpoints data table, a ticket table, a dispatch table, a dropship table, a products table, or a services table. In some implementations, the metadata may include one or more of table to column information metadata or table join information metadata.

As further shown in FIG. 4, process 400 may include transforming the raw data and the metadata into unified data (block 420). For example, the device may transform the raw data and the metadata into unified data, as described above. In some implementations, the unified data includes the raw data and the metadata provided in a standardized format required for further processing. In some implementations, transforming the raw data and the metadata into the unified data includes validating the raw data, the metadata, and datatypes associated with the raw data and the metadata; converting the datatypes associated with the raw data and the metadata into a standard datatype; fixing attributes associated with the raw data and the metadata; joining the raw data based on joining criteria provided in the metadata; converting names of the attributes into standard names; and converting data types of the attributes into a standard format.

As further shown in FIG. 4, process 400 may include processing the unified data, with a first model, to generate journey record derived variables, customer record derived variables, clickstream derived variables, and analytical matrices (block 430). For example, the device may process the unified data, with a first model, to generate journey record derived variables, customer record derived variables, clickstream derived variables, and analytical matrices, as described above. In some implementations, the journey record derived variables include analytical variables that are derived based on customer-specific data of the unified data, the customer record derived variables include analytical variables derived based on customer interaction level aggregated data of the unified data, the clickstream derived variables include clickstream specific derived signals merged with the journey record derived variables, and the analytical matrices include a matrix identifying a mean among data points of the unified data and a matrix identifying a variance among the data points of the unified data.

As further shown in FIG. 4, process 400 may include processing the unified data, the journey record derived variables, the customer record derived variables, the clickstream derived variables, and the analytical matrices, with a second model, to generate a journey data store with journey derived signals (block 440). For example, the device may process the unified data, the journey record derived variables, the customer record derived variables, the clickstream derived variables, and the analytical matrices, with a second model, to generate a journey data store with journey derived signals, as described above. In some implementations, the journey data store is an end-to-end stitched journey view table and the journey derived signals include derived attributes calculated from the journey data store. In some implementations, the journey derived signals include decision signals derived based on one or more of a customer journey and calculated based on interaction channels of the customer, whether the customer journey is complete or incomplete, whether the customer journey is successful or unsuccessful, touchpoints of the customer, a time granularity of customer journey, an intent of the customer journey, whether the customer journey includes human or non-human interaction, whether customer journey is digital or non-digital, or whether the journey includes multiple channels.

In some implementations, processing the unified data, the journey record derived variables, the customer record derived variables, the clickstream derived variables, and the analytical matrices, with the second model, to generate the journey data store with the journey derived signals includes identifying the customer with interactions based on a customer identifier, calculating a difference between start times of two interactions based on the customer identifier being associated with the two interactions, performing journey stitching based on the difference between the start times being less than or equal to a journey day, and providing the two interactions in the journey data store based on the customer identifier being associated with the two interactions and based on the difference between the start times being less than or equal to the journey day.

As further shown in FIG. 4, process 400 may include processing the unified data, the journey record derived variables, the customer record derived variables, the clickstream derived variables, the analytical matrices, and the journey data store, with a third model, to generate overall statistical data for the customer (block 450). For example, the device may process the unified data, the journey record derived variables, the customer record derived variables, the clickstream derived variables, the analytical matrices, and the journey data store, with a third model, to generate overall statistical data for the customer, as described above.

As further shown in FIG. 4, process 400 may include performing one or more actions based on the overall statistical data (block 460). For example, the device may perform one or more actions based on the overall statistical data, as described above. In some implementations, performing the one or more actions includes one or more of providing the overall statistical data for display, or providing a decision based on the overall statistical data. In some implementations, performing the one or more actions includes receiving feedback on the overall statistical data, and updating the overall statistical data based on the feedback. In some implementations, performing the one or more actions includes updating one or more of the unified data, the journey record derived variables, the customer record derived variables, the clickstream derived variables, the analytical matrices, or the journey data store based on the overall statistical data. In some implementations, performing the one or more actions includes retraining one or more of the first model, the second model, or the third model based on the overall statistical data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, raw data and metadata associated with a customer;
transforming, by the device, the raw data and the metadata into unified data;
processing, by the device, the unified data, with a first model, to generate journey record derived variables, customer record derived variables, clickstream derived variables, and analytical matrices;
processing, by the device, the unified data, the journey record derived variables, the customer record derived variables, the clickstream derived variables, and the analytical matrices, with a second model, to generate a journey data store with journey derived signals;
processing, by the device, the unified data, the journey record derived variables, the customer record derived variables, the clickstream derived variables, the analytical matrices, and the journey data store, with a third model, to generate overall statistical data for the customer; and
performing, by the device, one or more actions based on the overall statistical data.

2. The method of claim 1, wherein the raw data may include data provided in one or more of:
a customer table,
a billing table,
a touchpoints data table,
a ticket table,
a dispatch table,
a dropship table,
a products table, or
a services table.

3. The method of claim 1, wherein the metadata may include one or more of table to column information metadata or table join information metadata.

4. The method of claim 1, wherein the unified data includes the raw data and the metadata provided in a standardized format required for further processing.

5. The method of claim 1, wherein transforming the raw data and the metadata into the unified data comprises:
validating the raw data, the metadata, and datatypes associated with the raw data and the metadata;
converting the datatypes associated with the raw data and the metadata into a standard datatype;
fixing attributes associated with the raw data and the metadata;
joining the raw data based on joining criteria provided in the metadata;
converting names of the attributes into standard names; and
converting data types of the attributes into a standard format.

6. The method of claim 1, wherein:
the journey record derived variables include analytical variables that are derived based on customer-specific data of the unified data,
the customer record derived variables include analytical variables derived based on customer interaction level aggregated data of the unified data,
the clickstream derived variables include clickstream specific derived signals merged with the journey record derived variables, and
the analytical matrices include a matrix identifying a mean among data points of the unified data and a matrix identifying a variance among the data points of the unified data.

7. The method of claim 1, wherein the journey data store is an end-to-end stitched journey view table and the journey derived signals include derived attributes calculated from the journey data store.

8. A device, comprising:
one or more memories; and
one or more processors, coupled to the one or more memories, configured to:
receive raw data and metadata associated with a customer;
transform the raw data and the metadata into unified data;
process the unified data, with a first model, to generate journey record derived variables, customer record derived variables, clickstream derived variables, and analytical matrices;
process the unified data, the journey record derived variables, the customer record derived variables, the clickstream derived variables, and the analytical matrices, with a second model, to generate a journey data store with journey derived signals,
wherein the journey data store is an end-to-end stitched journey view table and the journey derived signals include derived attributes calculated from the journey data store;
process the unified data, the journey record derived variables, the customer record derived variables, the clickstream derived variables, the analytical matrices, and the journey data store, with a third model, to generate overall statistical data for the customer; and
perform one or more actions based on the overall statistical data.

9. The device of claim 8, wherein the journey derived signals include decision signals derived based on one or more of:
a customer journey and calculated based on interaction channels of the customer,
whether the customer journey is complete or incomplete,
whether the customer journey is successful or unsuccessful,
touchpoints of the customer,
a time granularity of customer journey,
an intent of the customer journey,
whether the customer journey includes human or non-human interaction,
whether customer journey is digital or non-digital, or
whether the customer journey includes multiple channels.

10. The device of claim 8, wherein the one or more processors, to process the unified data, the journey record derived variables, the customer record derived variables, the clickstream derived variables, and the analytical matrices, with the second model, to generate the journey data store with the journey derived signals, are configured to:
identify the customer with interactions based on a customer identifier;
calculate a difference between start times of two interactions based on the customer identifier being associated with the two interactions;
perform journey stitching based on the difference between the start times being less than or equal to a journey day; and
provide the two interactions in the journey data store based on the customer identifier being associated with the two interactions and based on the difference between the start times being less than or equal to the journey day.

11. The device of claim 8, wherein the one or more processors, to perform the one or more actions, are configured to one or more of:
provide the overall statistical data for display; or
provide a decision based on the overall statistical data.

12. The device of claim 8, wherein the one or more processors, to perform the one or more actions, are configured to:
receive feedback on the overall statistical data; and
update the overall statistical data based on the feedback.

13. The device of claim 8, wherein the one or more processors, to perform the one or more actions, are configured to:
update one or more of the unified data, the journey record derived variables, the customer record derived variables, the clickstream derived variables, the analytical matrices, or the journey data store based on the overall statistical data.

14. The device of claim 8, wherein the one or more processors, to perform the one or more actions, are configured to:
retrain one or more of the first model, the second model, or the third model based on the overall statistical data.

15. A non-transitory computer-readable medium storing a set of instructions, the set of instructions comprising:
one or more instructions that, when executed by one or more processors of a device, cause the device to:
receive raw data and metadata associated with a customer;
transform the raw data and the metadata into unified data;
process the unified data, with a first model, to generate journey record derived variables, customer record derived variables, clickstream derived variables, and analytical matrices;
process the unified data, the journey record derived variables, the customer record derived variables, the clickstream derived variables, and the analytical matrices, with a second model, to generate a journey data store with journey derived signals;
process the unified data, the journey record derived variables, the customer record derived variables, the clickstream derived variables, the analytical matrices, and the journey data store, with a third model, to generate overall statistical data for the customer; and
provide the overall statistical data for display.

16. The non-transitory computer-readable medium of claim 15, wherein the unified data includes the raw data and the metadata provided in a standardized format required for further processing.

17. The non-transitory computer-readable medium of claim 15, wherein the one or more instructions, that cause the device to transform the raw data and the metadata into the unified data, cause the device to:
validate the raw data, the metadata, and datatypes associated with the raw data and the metadata;
convert the datatypes associated with the raw data and the metadata into a standard datatype;
fix attributes associated with the raw data and the metadata;
join the raw data based on joining criteria provided in the metadata;
convert names of the attributes into standard names; and
convert data types of the attributes into a standard format.

18. The non-transitory computer-readable medium of claim 15, wherein:
the journey record derived variables include analytical variables that are derived based on customer-specific data of the unified data,
the customer record derived variables include analytical variables derived based on customer interaction level aggregated data of the unified data,
the clickstream derived variables include clickstream specific derived signals merged with the journey record derived variables, and
the analytical matrices include a matrix identifying a mean among data points of the unified data and a matrix identifying a variance among the data points of the unified data.

19. The non-transitory computer-readable medium of claim 15, wherein the one or more instructions, that cause the device to process the unified data, the journey record derived variables, the customer record derived variables, the clickstream derived variables, and the analytical matrices, with the second model, to generate the journey data store with the journey derived signals, cause the device to:
identify the customer with interactions based on a customer identifier;
calculate a difference between start times of two interactions based on the customer identifier being associated with the two interactions;
perform journey stitching based on the difference between the start times being less than or equal a journey day; and
provide the two interactions in the journey data store based on the customer identifier being associated with the two interactions and based on the difference between the start times being less than or equal a journey day.

20. The non-transitory computer-readable medium of claim 15, wherein the one or more instructions, further cause the device to one or more of:
provide a decision based on the overall statistical data;
receive feedback on the overall statistical data and update the overall statistical data based on the feedback;
update one or more of the unified data, the journey record derived variables, the customer record derived variables, the clickstream derived variables, the analytical matrices, or the journey data store based on the overall statistical data; or
retrain one or more of the first model, the second model, or the third model based on the overall statistical data.
